(19) United States
(12) Patent Application Publication
(10) Pub. No.: US 2023/0311769 A1
(43) Pub. Date: Oct. 5, 2023

(54) SYSTEM AND METHOD FOR AN AGRICULTURAL APPLICATOR

(71) Applicant: CNH Industrial America LLC, New Holland, PA (US)

(72) Inventor: Yogesh Sheth, Kenosha, WI (US)

(21) Appl. No.: 17/710,020

(22) Filed: Mar. 31, 2022

(51) Int. Cl. B60R 1/24; A01M 7/00; B60Q 9/00; A01C 23/00

(52) U.S. Cl. CPC B60R 1/24; A01M 7/0057; B60Q 9/00; A01C 23/008; B60R 2300/305; A01M 7/0042; A01C 23/047

(57) ABSTRACT

An agricultural system includes a boom assembly. An imager assembly is associated with the boom assembly and configured to capture image data depicting at least a portion of the boom assembly. A computing system is communicatively coupled to the imager assembly and a display. The computing system is configured to receive the image data from the imager assembly and present a graphic on the display based on the image data. The graphic can include at least one overlaid illustration.

### FIELD

The present disclosure generally relates to agricultural vehicles and, more particularly, to systems and methods for monitoring components of the agricultural vehicle.

### BACKGROUND

Various types of vehicles utilize applicators (e.g., sprayers, floaters, etc.) to deliver an agricultural product to a ground surface of a field. The agricultural product may be in the form of a solution or mixture, with a carrier (such as water) being mixed with one or more active ingredients (such as an herbicide, agricultural product, fungicide, a pesticide, or another product).

The applicators may be pulled as an implement or self-propelled and can include a tank, a pump, a boom assembly, and a plurality of nozzles carried by the boom assembly at spaced locations. The boom assembly can include a pair of boom arms, with each boom arm extending to either side of the applicator when in an unfolded state. Each boom arm may include multiple boom sections, each with a number of spray nozzles (also sometimes referred to as spray tips).

During the operation of the agricultural vehicle, however, it can be difficult to monitor each boom arm, among other components of the vehicle. Accordingly, an improved system and method for monitoring the boom arm and/or other components of the agricultural vehicle would be welcomed in the technology.

### BRIEF DESCRIPTION

Aspects and advantages of the technology will be set forth in part in the following description, or may be obvious from the description, or may be learned through practice of the technology.

In some aspects, the present subject matter is directed to an agricultural system comprising a boom assembly. An imager assembly is associated with the boom assembly and is configured to capture image data depicting at least a portion of the boom assembly. A computing system is communicatively coupled to the imager assembly and a display. The computing system is configured to receive the image data from the imager assembly and present a graphic on the display based on the image data. The graphic includes at least one overlaid illustration.

In some aspects, the present subject matter is directed to a method for an agricultural application operation. The method includes generating, with an imager assembly positioned on a boom assembly, image data. The method also includes detecting, with a computing system, one or more objects within the image data. The method further includes generating, with the computing system, an overlaid illustration. Lastly, the method includes presenting, on a display, a graphic that includes the one or more images and the overlaid image.

In some aspects, the present subject matter is directed to an agricultural system that includes a vehicle and a boom assembly operably coupled with the vehicle. An imager assembly is associated with the boom assembly and is configured to capture image data depicting at least a first portion of the boom assembly. A computing system is communicatively coupled to the imager assembly and a display. The computing system is configured to receive the image data from the imager assembly; determine one or more objects within the image data; identify an obstruction within the one or more objects; and generate an output based on a location of the obstruction relative to the boom assembly.

These and other features, aspects, and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of an agricultural vehicle in accordance with aspects of the present subject matter;

FIG. 2 illustrates a side view of the vehicle in accordance with aspects of the present subject matter;

FIG. 3 is a rear view of a boom assembly that may be operably coupled with the vehicle in accordance with aspects of the present subject matter;

FIG. 4 is a perspective view of a cab of the vehicle in accordance with aspects of the present subject matter;

FIG. 5 illustrates a block diagram of components of the agricultural applicator system in accordance with aspects of the present subject matter;

FIG. 6 is a rear perspective view of the vehicle and the boom assembly within a field in accordance with aspects of the present subject matter;

FIG. 7 is a top perspective view of the vehicle and the boom assembly within the field in accordance with aspects of the present subject matter;

FIG. 8 is an enhanced view of area VIII of FIG. 6 in accordance with aspects of the present subject matter;

FIG. 9 is a graphic provided on a display that includes locus lines in accordance with aspects of the present subject matter;

FIG. 10 is a graphic provided on a display that includes locus lines in accordance with aspects of the present subject matter;

FIG. 11 is a graphic provided on a display that includes zones of interest in accordance with aspects of the present subject matter;

FIG. 12 is a graphic provided on a display that includes a clearance notification in accordance with aspects of the present subject matter;

FIG. 13 is a graphic provided on a display that includes one or more spray patterns in accordance with aspects of the present subject matter;

FIG. 14 is a graphic provided on a display that includes identified rows of crops in accordance with aspects of the present subject matter; and

FIG. 15 is a graphic provided on a display that a generated birds eye view of the agricultural vehicle in accordance with aspects of the present subject matter;

FIG. 16 is a graphic provided on a display that a generated birds eye view of the agricultural vehicle in accordance with aspects of the present subject matter; and

FIG. 17 illustrates a flow diagram of a method for an agricultural application operation in accordance with aspects of the present subject matter.

Repeat use of reference characters in the present specification and drawings is intended to represent the same or analogous features or elements of the present technology.

### DETAILED DESCRIPTION

Reference now will be made in detail to embodiments of the disclosure, one or more examples of which are illustrated in the drawings. Each example is provided by way of explanation of the discourse, not limitation of the disclosure. In fact, it will be apparent to those skilled in the art that various modifications and variations can be made in the present disclosure without departing from the scope or spirit of the disclosure. For instance, features illustrated or described as part can be used with another embodiment to yield a still further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to an agricultural product within a fluid circuit. For example, “upstream” refers to the direction from which an agricultural product flows, and “downstream” refers to the direction to which the agricultural product moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, in some implementations, the present subject matter is directed to an agricultural system that includes a boom assembly. The boom assembly may be operably coupled with a vehicle and can include one or more nozzle assemblies that are configured to dispense an agricultural product onto the underlying ground surface (e.g., plants and/or soil).

In various examples, an imager assembly may be associated with the boom assembly and may be configured to capture image data depicting an area proximate to (e.g., forwardly, rearwardly, laterally outward, laterally inward, above, and/or below the boom assembly and/or the imager assembly) at least a portion of the boom assembly. Each imager assembly may include one or more imagers that may capture two-dimensional images or a stereo camera having two or more lenses with a separate image imaging device for each lens to allow the camera to capture stereographic or three-dimensional images. Alternatively, the imagers may correspond to any other suitable image capture devices and/or other imaging devices capable of capturing “images” or other image-like data that can be processed to differentiate one portion of the data from a separate portion of the data.

A computing system may be communicatively coupled to the imager assembly and a display. The computing system can be configured to receive the image data from the imager assembly and present a graphic on the display based on the image data. The graphic includes at least one overlaid illustration, which may assist an operator during the operation of the vehicle. In various examples, the overlaid illustration may include locus lines, one or more zones of interest, a clearance notification, a projected spray zone for one or more respective nozzle assemblies, identified rows of crop, and/or any other illustration.

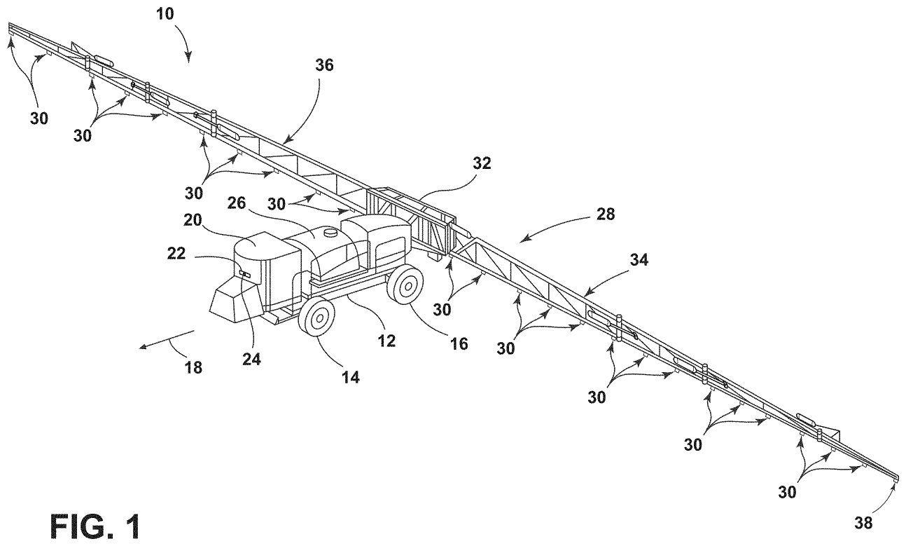

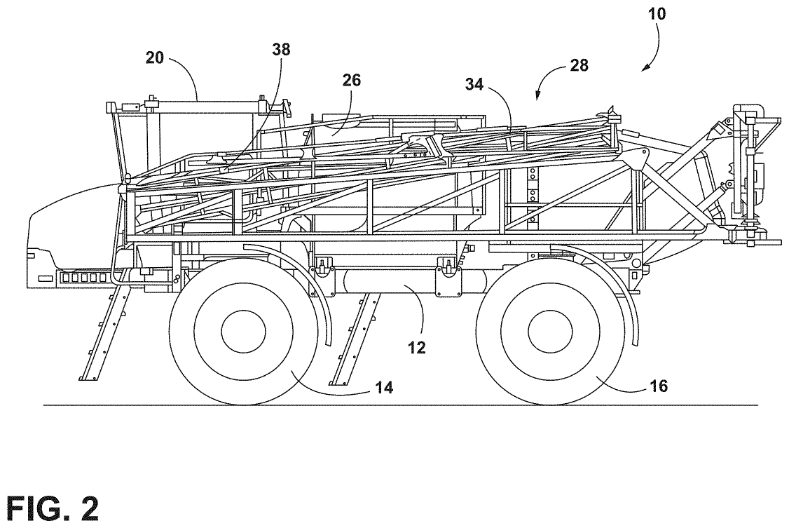

Referring now to FIGS. 1 and 2, a vehicle 10 is generally illustrated as a self-propelled agricultural applicator. However, in alternate embodiments, the vehicle 10 may be configured as any other suitable type of vehicle 10 configured to perform agricultural application operations, such as a tractor or other vehicle configured to haul or tow an application implement.

In various embodiments, the vehicle 10 may include a chassis 12 configured to support or couple to a plurality of components. For example, front and rear wheels 14, 16 may be coupled to the chassis 12. The wheels 14, 16 may be configured to support the vehicle 10 relative to a ground surface and move the vehicle 10 in a direction of travel (e.g., as indicated by arrow 18 in FIG. 1) across a field or the ground surface. In this regard, the vehicle 10 may include a power plant, such as an engine, a motor, or a hybrid engine-motor combination, to move the vehicle 10 along a field.

The chassis 12 may also support a cab 20, or any other form of operator's station, that provides various control or input devices (e.g., levers, pedals, control panels, buttons, and/or the like) for providing various notifications to an operator and/or permitting the operator to control the operation of the vehicle 10. For instance, as shown in FIG. 1, the vehicle 10 may include a human-machine interface (HMI) 22 for displaying messages and/or alerts to the operator and/or for allowing the operator to interface with the vehicle's controller through one or more user input devices 24.

The chassis 12 may also support a tank 26 and a boom assembly 28 mounted to the chassis 12. The tank 26 is generally configured to store or hold an agricultural product, such as a pesticide, a fungicide, a rodenticide, a fertilizer, a nutrient, and/or the like. The agricultural product stored in the tank 26 may be dispensed onto the underlying ground surface (e.g., plants and/or soil) through one or more nozzle assemblies 30 mounted on the boom assembly 28.

As shown in FIGS. 1 and 2, the boom assembly 28 can include a frame 32 that supports first and second boom arms 34, 36 in a cantilevered nature. The first and second boom arms 34, 36 are generally movable between an operative or unfolded position (FIG. 1) and an inoperative or folded position (FIG. 2). When distributing the product, the first and/or second boom arm 34, 36 extends laterally outward from the vehicle 10 to cover wide swaths of soil, as illustrated in FIG. 1. However, to facilitate transport, each boom arm 34, 36 of the boom assembly 28 may be independently folded forwardly or rearwardly into the inoperative position, thereby reducing the overall width of the vehicle 10, or in some examples, the overall width of a towable implement when the applicator is configured to be towed behind the vehicle 10.

In some examples, one or more imager assemblies 38 may be positioned on the boom assembly 28, and/or on any other portion of the vehicle 10. The imager assemblies 38 may be configured to collect one or more images or image-like data indicative of an area surrounding the imager assemblies 38. In turn, the one or more images or image-like data may be used to provide an operator of the vehicle 10 with additional information related to the operation of the vehicle 10. It will be appreciated that the one or more images or image-like data may be collected with the boom assembly 28 in the operative or unfolded position (FIG. 1) and/or the inoperative or folded position (FIG. 2).

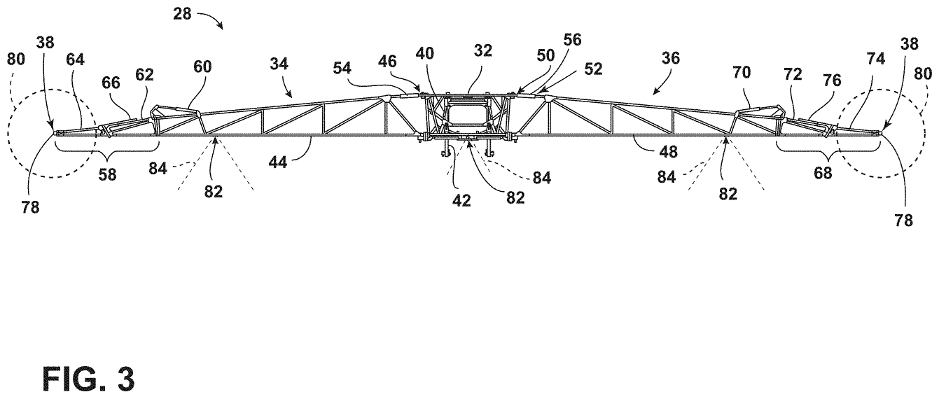

Referring to FIG. 3, the boom assembly 28 includes a mast 40 coupled to a frame 32 that, in combination, can support the boom assembly 28 on the vehicle 10. In some embodiments, such as the one illustrated in FIG. 3, the mast 40 is configured to couple to the vehicle 10 (FIG. 2) via a linkage assembly 42. The frame 32 is further configured to support the first and second boom arms 34, 36 during operation and transport. As illustrated, the first and second boom arms 34, 36 are coupled to and extend from opposing side portions of the frame 32. In some examples, an inner section 44 of the first boom arm 34 is pivotally coupled to a first lateral side portion 46 of the frame 32, and an inner section 48 of the second boom arm 36 is coupled to an opposite, second lateral side portion 50 of the frame 32. In this configuration, the first and second boom arms 34, 36 may be folded forwardly or rearwardly from the illustrated operative position to an inoperative position that reduces the overall width of the vehicle 10.

In some examples, such as the embodiment illustrated in FIG. 3, the boom assembly 28 includes a positioning assembly 52 operably coupled to the frame 32 and the first and second boom arms 34, 36. The positioning assembly 52 may be configured to independently move each of the first and second boom arms 34, 36 between the extended and folded positions. For example, in some embodiments, the first boom arm 34 can include an actuating device 54 (e.g., electromechanical actuator, hydraulic cylinder, and/or pneumatic cylinder) extending between the inner section 44 of the first boom arm 34 and the frame 32. Additionally or alternatively, in various embodiments, the second boom arm 34 can include an actuating device 54 (e.g., electromechanical actuator, hydraulic cylinder, and/or pneumatic cylinder) extending between the inner section 44 of the second boom arm 36 and the frame 32.

The first boom arm 34 can also include an outer portion 58 having a peripheral actuating device 60. As illustrated, the outer portion 58 is coupled to the inner section 44 by a pivotal joint. Like the actuating device 54, the peripheral actuating device 60 may be an electromechanical actuator, hydraulic cylinder, and/or pneumatic cylinder. Retracting the piston rod of the device 60 will cause the outer portion 58 to rotate from the illustrated product distribution/operative position to an inoperative position.

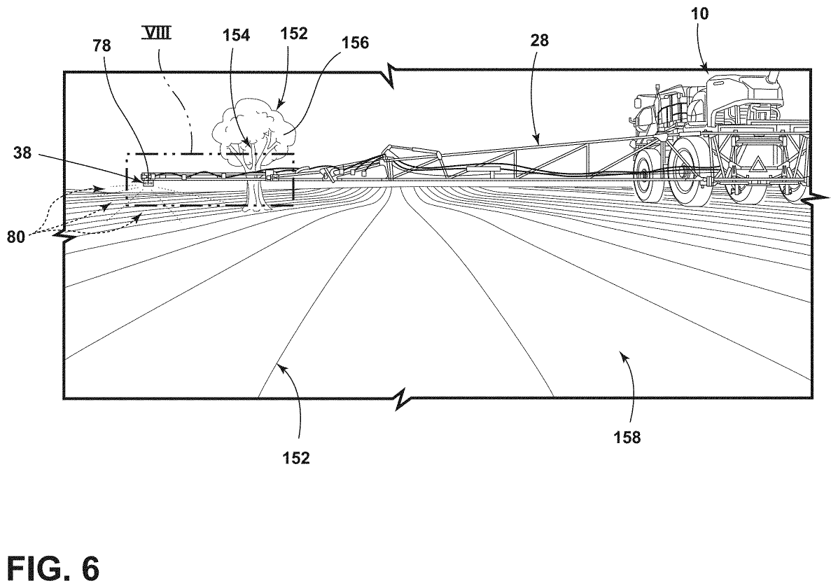

In the illustrated embodiment, the outer portion 58 includes an outer section 62, a breakaway section 64, and a biasing member 66. The outer section 62 extends between the inner section 44 and the breakaway section 64. The breakaway section 64 is pivotally coupled to the outer section 62 by a joint, and the biasing member 66 is configured to urge the breakaway section 64 toward an operative, default position. In this configuration, contact between the breakaway section 64 and an obstruction 154 (FIG. 6) can drive the breakaway section to rotate. After the boom has passed the obstruction 154 (FIG. 6), the biasing member 66 will urge the breakaway section back to the default position.

The structure of the second boom arm 36 is similar to the structure of the first boom arm 34. For instance, the second boom arm 36 can include an actuating device 56 (e.g., electromechanical actuator, hydraulic cylinder, and/or pneumatic cylinder) extending between the inner section 48 and the frame 32. The second boom arm 36 also includes an outer portion 68 having a peripheral actuating device 70. As illustrated, the outer portion 68 is coupled to the inner section 48 by a pivotal joint. Like the actuating device 56, the peripheral actuating device 70 may be an electromechanical actuator, hydraulic cylinder, and/or pneumatic cylinder configured to rotate the outer portion 68 relative to the inner section 48 by electromechanically rotating the outer portion 68 and/or displacing a piston rod extending from the peripheral actuating device 70. Retracting the piston rod of the peripheral actuating device 70 will cause the outer portion 68 to rotate from the illustrated product distribution/operative position to an inoperative position.

In the illustrated embodiment, the outer portion 68 also includes an outer section 72, a breakaway section 74, and a biasing member 76. The outer section 72 extends between the inner section 48 and the breakaway section 74. The breakaway section 74 is pivotally coupled to the outer section 72 by a joint, and the biasing member 76 is configured to urge the breakaway section 74 toward the illustrated operative, default position. In this configuration, contact between the breakaway section 74 and an obstruction 154 (FIG. 6) will drive the breakaway section to rotate. After the boom has passed the obstruction 154 (FIG. 6), the biasing member 76 will urge the breakaway section back to the default position. Although the boom assembly 28 is shown in FIG. 3 as including first and second boom arms 34, 36 each having an inner section and an outer portion coupled to each side portion of the frame 32, the boom assembly 28 may generally have any suitable number of boom arms 34, 36.

With further reference to FIG. 3, in various embodiments, the boom assembly 28 may include one or more imager assemblies 38. As provided herein, each imager assembly 38 may be configured to generate image data of an area surrounding the imager assemblies 38. Each of the imagers 78 may have a field of view directed toward a predefined location as generally illustrated by dashed lines 80 in FIG. 3. In turn, the data may be used to provide an operator of the vehicle 10 with additional information related to the operation of the vehicle 10. Each imager assembly 38 may include one or more imagers 78 that may correspond to any suitable camera, such as single-spectrum camera or a multi-spectrum camera configured to capture images, for example, in the visible light range and/or infrared spectral range. Additionally, in various embodiments, the camera may correspond to a single lens camera configured to capture two-dimensional images or a stereo camera having two or more lenses with a separate image imaging device for each lens to allow the camera to capture stereographic or three-dimensional images. Alternatively, the imagers 78 may correspond to any other suitable image capture devices and/or other imaging devices capable of capturing “images” or other image-like data. For example, the imagers 78 may correspond to or include radio detection and ranging (RADAR) sensors, light detection and ranging (LIDAR) sensors, and/or any other practicable device.

With further reference to FIG. 3, the vehicle 10 may further include one or more sensors 82 in addition to the imager assemblies 38 and/or in lieu of the imager assemblies 38. The one or more sensors 82 may be configured to capture data indicative of an operating condition of the vehicle 10. For example, the one or more sensors 82 may be configured to collect data indicative of an orientation or position of the boom assembly 28 relative to the ground surface and/or data associated with one or more application conditions. In some instances, the one or more sensors 82 may be installed or otherwise positioned on the boom assembly 28. For example, as shown in FIG. 3, a sensor 82 may be positioned on each of the first and second boom arms 34, 36. Each of the sensors 82 may have a field of view directed toward a predefined location as generally illustrated by dashed lines 84 in FIG. 3. In some examples, the one or more sensors 82 may additionally or alternatively be positioned at any other suitable location(s) on and/or coupled to any other suitable component(s) of the vehicle 10.

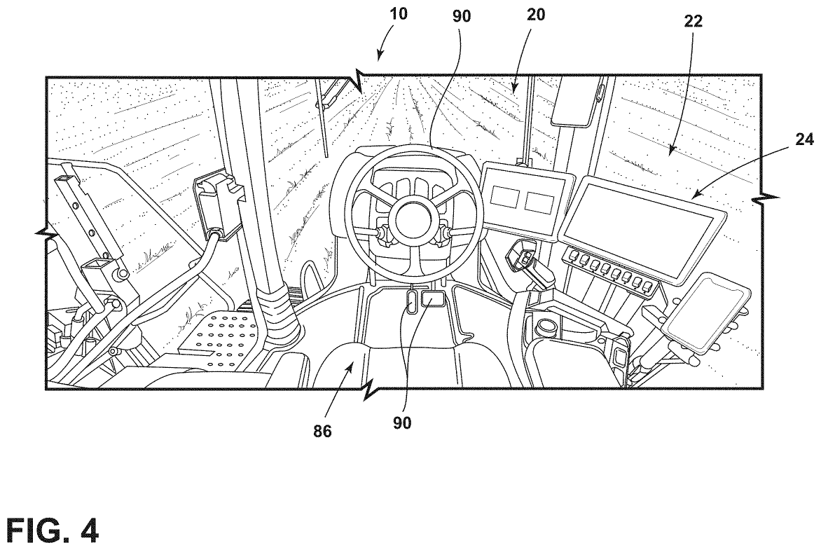

Referring now to FIG. 4, an interior of the cab 20 of the vehicle 10 may include a seat 86, on which the operator sits when operating the vehicle 10. In various embodiments, a steering wheel 88 is located near the seat 86, so as to be within arm's reach of the operator when the operator is seated. Though a steering wheel 88 is included in the illustrated embodiment, other embodiments of the vehicle 10 may include other devices for receiving steering inputs from the operator. For example, in place of a steering wheel 88, the cab 20 may have left/right control bars, a hand controller, pedals 90, or another suitable device for receiving steering inputs. The vehicle 10 may further include one or more pedals 90 that may be configured to receive input from the operator for controlling the speed of the vehicle 10. For example, the pedals 90 may control a throttle, brakes, a clutch, other suitable systems, or a combination thereof. In other embodiments, pedals 90 may be used for steering inputs. Further, in embodiments in which the vehicle 10 is semi-autonomous or fully autonomous, the steering wheel 88 and/or the pedals 90 may be omitted.

The HMI 22 may also be positioned within the cab 20 and may be used to present information to the operator, such as vehicle information (e.g., ground speed, oil pressure, engine temperature, etc.), implement operations information (e.g., rotor speed and grain loss), and manufacturer proprietary systems information (e.g. Advanced Farming Systems (AFS) information, including yield maps, position data, etc.). In addition, the HMI 22 may also be capable of presenting and displaying data associated with the one or more imager assemblies 38. For instance, images or illustrations of an area surrounding the imager assembly 38 may be illustrated on the display. In some instances, the illustration on the display may be a combined, stitched image that is generated based on data from more than a single imager 78. Additionally, or alternatively, the illustration may be at least partially based on data that is provided from a source external to the vehicle 10 and/or generated during a previous operation of the vehicle 10.

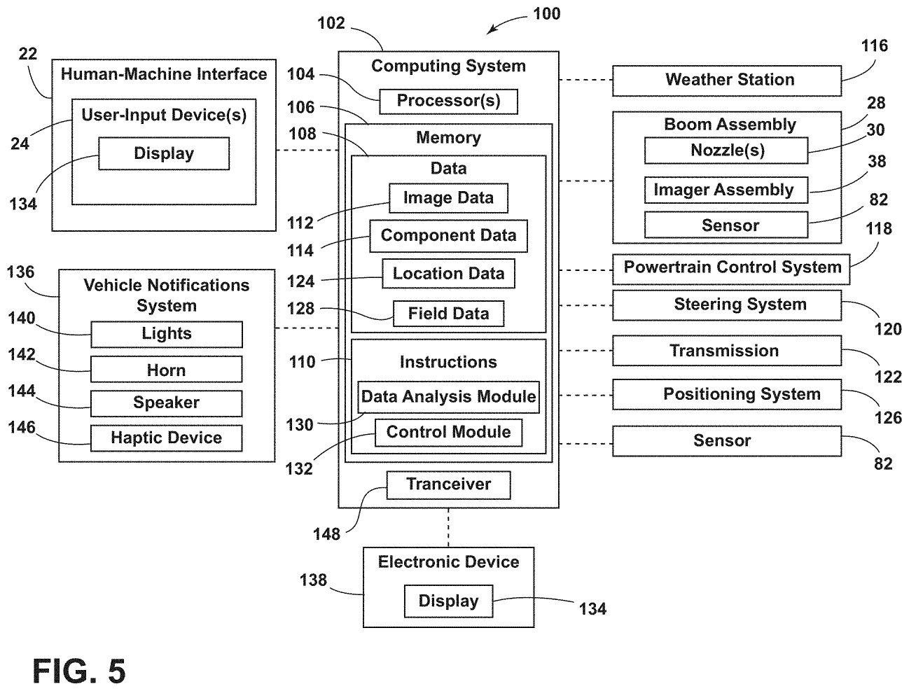

Referring now to FIG. 5, a schematic view of a system 100 for operating the vehicle 10 is illustrated in accordance with aspects of the present subject matter. In general, the system 100 will be described with reference to the vehicle 10 described above with reference to FIGS. 1-4. However, it should be appreciated by those of ordinary skill in the art that the disclosed system 100 may generally be utilized with agricultural machines having any other suitable machine configuration. Additionally, it should be appreciated that, for purposes of illustration, communicative links, or electrical couplings of the system 100 shown in FIG. 4 are indicated by arrows.

As shown in FIG. 5, the system 100 may include one or more imager assemblies 38 configured to capture image data depicting at least a portion of the boom assembly 28. The system 100 may further include a computing system 102 communicatively coupled to the one or more imager assemblies 38. In several embodiments, the computing system 102 may be configured to receive the image data from the imager assemblies 38 and present a graphic on a display based on the image data with the graphic including at least one overlaid illustration. Additionally or alternatively, the computing system 102 may be configured to receive the image data from the imager assembly 38, determine one or more objects 152 (FIG. 6) within the image data, identify an obstruction 154 (FIG. 6) (FIG. 6) within the one or more objects 152 (FIG. 6), and generate an output based on a location of the obstruction 154 (FIG. 6) relative to the boom assembly 28.

In general, the computing system 102 may comprise any suitable processor-based device, such as a computing device or any suitable combination of computing devices. Thus, in several embodiments, the computing system 102 may include one or more processors 104 and associated memory 106 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory 106 of the computing system 102 may generally comprise memory elements including, but not limited to, a computer readable medium (e.g., random access memory (RAM)), a computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory 106 may generally be configured to store information accessible to the processor 104, including data 108 that can be retrieved, manipulated, created, and/or stored by the processor 104 and instructions 110 that can be executed by the processor 104, when implemented by the processor 104, configure the computing system 102 to perform various computer-implemented functions, such as one or more aspects of the image processing algorithms and/or related methods described herein. In addition, the computing system 102 may also include various other suitable components, such as a communications circuit or module, one or more input/output channels, a data/control bus, and/or the like.

In various embodiments, the computing system 102 may correspond to an existing controller of the agricultural vehicle 10, or the computing system 102 may correspond to a separate processing device. For instance, in some embodiments, the computing system 102 may form all or part of a separate plug-in module or computing device that is installed relative to the vehicle 10 or the boom assembly 28 to allow for the disclosed system 100 and method to be implemented without requiring additional software to be uploaded onto existing control devices of the vehicle 10 or the boom assembly 28. Further, the various functions of the computing system 102 may be performed by a single processor-based device or may be distributed across any number of processor-based devices, in which instance such devices may be considered to form part of the computing system 102. For instance, the functions of the computing system 102 may be distributed across multiple application-specific controllers.

In several embodiments, the data 108 may be information received and/or generated by the computing system 102 that is stored in one or more databases. For instance, as shown in FIG. 5, the memory 106 may include an image database 112 for storing image data (e.g., one or more images and/or image-like data) that is received from the one or more imager assemblies 38. Moreover, in addition to initial or raw sensor data received from the one or more imager assemblies 38, final or post-processing image data (as well as any intermediate image data created during data processing) may also be stored within the image database 112.

In various embodiments, the memory 106 may also include a component database 114 that stores information related to various components of the vehicle 10. The component information may include conditions of each component during operation, such as whether the component is in its default position and/or has deviated from its default position. The component data may be received from a weather station 116, one or more sensors 82, which may be associated with the boom assembly 28 and/or any other component of the vehicle 10, a powertrain control system 118, a steering system 120, a transmission system 122, and/or any other component or system of the vehicle 10. Additionally or alternatively, the component information may include characteristics related to the component, such as the dimensions of each component, the position of each component, etc. In some instances, the component information may be preloaded or sent to the vehicle 10 via wired or wireless communication therewith. Additionally or alternatively, the component information may be manually inputted into the component database 114. Additionally or alternatively, the component information may be detected by one or more sensors (e.g., sensor 82).

Additionally, in several embodiments, the memory 106 may also include a location database 124 storing location data of the vehicle 10 and/or the boom assembly 28. For example, in some embodiments, the positioning system 126 may be configured to determine the location of the vehicle 10 and/or the boom assembly 28 by using a positioning system 126 (e.g. a Global Positioning System (GPS), a Galileo positioning system, the Global Navigation satellite system (GLONASS), the BeiDou Satellite Navigation and Positioning system, a dead reckoning device, and/or the like). The location determined by the positioning system 126 may be transmitted to the computing system 102 (e.g., in the form location coordinates) and subsequently stored within the location database 124 for subsequent processing and/or analysis.

In several embodiments, the location data stored within the location database 124 may also be correlated to the image data stored within the image database 112. For instance, in some embodiments, the location coordinates derived from the positioning system 126 and the image data captured by the one or more imager assemblies 38 may both be time-stamped. In such embodiments, the time-stamped data may allow each individual set of image data captured by the one or more imager assemblies 38 to be matched or correlated to a corresponding set of location coordinates received from the positioning system 126, thereby allowing the image data to be associated with a location of the field.

Additionally, in some embodiments, the memory 106 may include a field database 128 for storing information related to the field, such as application map data, boundary map data, object map data, and/or any other data. In such embodiments, the computing system 102 may be configured to generate or update a map associated with the field, which may then be stored within the field database 128 for subsequent processing and/or analysis.

With further reference to FIG. 5, in several embodiments, the instructions 110 stored within the memory 106 of the computing system 102 may be executed by the processor 104 to implement a data analysis module 130 and/or a control module 132 to analyze the data 108. The data analysis module 130 and/or a control module 132 may utilize any data processing techniques or algorithms, such as by applying corrections or adjustments to the data, filtering the data to remove outliers, implementing sub-routines or intermediate calculations, and/or by performing any other desired data processing-related techniques or algorithms.

In general, the data analysis module 130 may be configured to analyze the data to determine a position of a component of the vehicle 10, such as the boom assembly 28 and/or nozzle assemblies 30 positioned along the boom assembly 28, relative to objects 152 (FIG. 6) within the field. In various examples, the objects 152 (FIG. 6) may include obstructions 154 (FIG. 6), which may be in the form of a building, a tree, a fence, and/or any other object 152 (FIG. 6) that is to be avoided. The objects 152 (FIG. 6) may also include the crops or other materials within the field that may have the agricultural product applied thereto.

In some instances, the data analysis module 130 may utilize the image data, the component data, the location data, and/or the field data to identify any objects 152 (FIG. 6) proximate to the boom assembly 28 and/or a current state of the boom assembly 28. In this regard, the computing system 102 may include any suitable image processing algorithms stored within its memory 106 or may otherwise use any suitable processing techniques to generate, for example, information related to the boom assembly 28 (or the vehicle 10) within its environment. In some examples, the data analysis module 130 may generate a composite image of the boom assembly 28 (or any other component) relative to its surrounding environment based on data from multiple imagers 78. In some embodiments, the composite image map may be a two-dimensional point cloud and/or a three-dimensional image point cloud, e.g., a set of X, Y, and Z coordinates of the segments. Additionally or alternatively, the data analysis module 130 may determine a distance between the boom assembly 28 (or other components) and various objects 152 (FIG. 6) and generate various instructions based on the distances between the boom assembly 28 and the objects 152 (FIG. 6).

The control module 132 may provide instructions 110 for various components communicatively coupled with the computing system 102 based on the information generated by the data analysis module 130. For example, the control module 132 may be capable of instructing a display 134 to present one or more graphics of the boom assembly 28 (or portions thereof) and/or one or more objects 152 (FIG. 6) proximate to the boom assembly 28. In some instances, the operator may input a type of object 152 (FIG. 6) to be presented and, in response, that type of object 152 (FIG. 6) may be presented, when detected, while non-chosen objects 152 (FIG. 6) may not be presented. For instance, the operator may choose to illustrate obstructions 154 (FIG. 6), when present, and not present the crops, the field, and/or any other material (e.g., residue) within the field. In some instances, the graphic includes at least one overlaid illustration, which may assist an operator during the operation of the vehicle 10. In various examples, the overlaid illustration may include locus lines, one or more zones of interest, a clearance notification, a projected spray zone for one or more respective nozzle assemblies 30, identified rows of crop, and/or any other illustration.

Additionally or alternatively, the control module 132 may be capable of altering a system or component of the vehicle 10. For instance, the system 100 may adjust the position of the boom assembly 28 when the system detects there is a possibility of contact between the boom assembly 28 and an obstruction 154 (FIG. 6). Additionally, or alternatively, in some examples, the control module 132 may alter the operation of the vehicle 10 to pause or otherwise change the operation of the vehicle 10 in response to determining that there is a possibility of contact between the boom assembly 28 and an obstruction 154 (FIG. 6) and/or for any other reason.

In some embodiments, the control module 132 may further provide notifications and/or instructions to the user HMI 22, a vehicle notification system 136, and/or a remote electronic device 138. In some examples, the display 134 of the user HMI 22 may be capable of displaying information related to the environment surrounding the imager assembly 38. The vehicle notification system 136 may prompt visual, auditory, and tactile notifications and/or warnings when one or more components may come in contact with an object 152 (FIG. 6) and/or one or more components of the vehicle 10 or the boom assembly 28 is altered by the computing system 102. For instance, vehicle lights 140 and/or vehicle emergency flashers may provide a visual alert. A vehicle horn 142 and/or speaker 144 may provide an audible alert. A haptic device 146 integrated into the cab 20 and/or any other location may provide a tactile alert. Additionally, the computing system 102 and/or the vehicle notification system 136 may communicate with the user HMI 22 of the vehicle 10. In addition to providing the notification to the user, the computing system 102 may additionally store the location of the vehicle 10 at the time of the notification.

Further, the computing system 102 may communicate via wired and/or wireless communication with one or more remote electronic devices 138 through a transceiver 148. The network may be one or more of various wired or wireless communication mechanisms, including any combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary wireless communication networks include a wireless transceiver (e.g., a BLUETOOTH module, a ZIGBEE transceiver, a Wi-Fi transceiver, an IrDA transceiver, an RFID transceiver, etc.), local area networks (LAN), and/or wide area networks (WAN), including the Internet, providing data communication services.

The electronic device 138 may also include a display 134 for displaying information to a user. For instance, the electronic device 138 may provide one or more user interfaces and may be capable of receiving remote user inputs to input any information. In addition, the electronic device 138 may provide feedback information, such as visual, audible, and tactile alerts, and/or allow the user to alter or adjust one or more components of the vehicle 10 or the boom assembly 28 (FIG. 1) through the usage of the remote electronic device 138. It will be appreciated that the electronic device 138 may be any one of a variety of computing devices and may include a processor and memory. For example, the electronic device 138 may be a cell phone, mobile communication device, key fob, wearable device (e.g., fitness band, watch, glasses, jewelry, wallet), apparel (e.g., a tee shirt, gloves, shoes, or other accessories), personal digital assistant, headphones and/or other devices that include capabilities for wireless communications and/or any wired communications protocols.

Although the various control functions and/or actions are generally described herein as being executed by the computing system 102, one or more of such control functions/actions (or portions thereof) may be executed by a separate computing system 102 or may be distributed across two or more computing systems (including, for example, the computing system 102 and a separate computing system). For instance, in some embodiments, the computing system 102 may be configured to acquire data from the image for subsequent processing and/or analysis by a separate computing system (e.g., a computing system associated with a remote server). In other embodiments, the computing system 102 may be configured to execute the data analysis module 130, while a separate computing system (e.g., a vehicle computing system associated with the agricultural vehicle 10) may be configured to execute the control module 132 to control the operation of the agricultural vehicle 10 based on data and/or outputs transmitted from the computing system 102 that are associated with the monitored objects 152 (FIG. 6) and/or field conditions. Likewise, in some embodiments, the computing system 102 may be configured to acquire data from the imager assembly 38 for subsequent processing and/or analysis by a separate computing system (e.g., a computing system associated with a remote server).

In various examples, the system 100 may implement machine learning engine methods and algorithms that utilize one or several machine learning techniques including, for example, decision tree learning, including, for example, random forest or conditional inference trees methods, neural networks, support vector machines, clustering, and Bayesian networks. These algorithms can include computer-executable code that can be retrieved by the computing system 102 and may be used to generate a predictive evaluation of the alterations to the vehicle 10. For instance, the control module 132 may alter the position of the boom assembly 28. In turn, the system 100 may monitor whether a likelihood of contact between the boom assembly 28 and the obstruction 154 (FIG. 6) still exists. Each change may be fed back into the data analysis module 130 and the control module 132 for further alterations to the boom assembly 28.

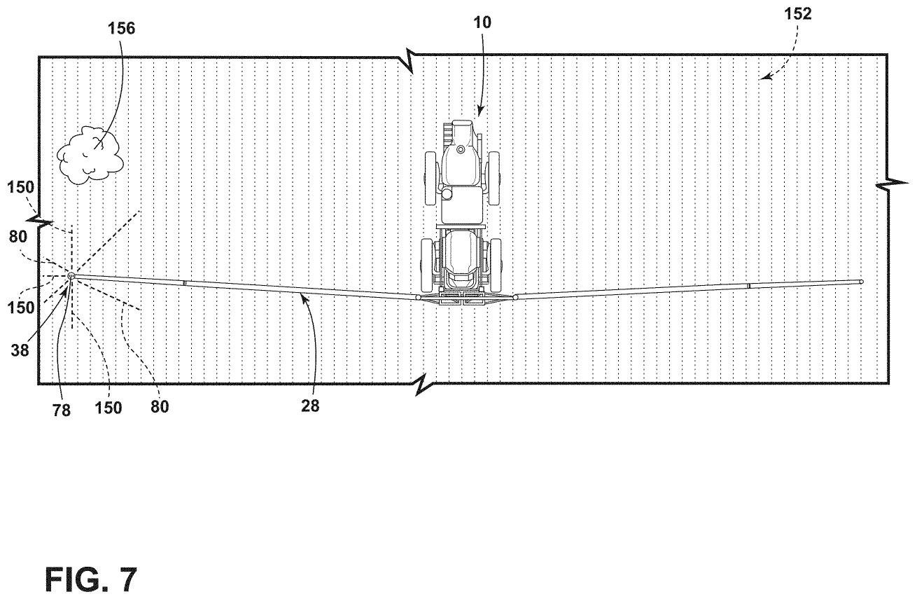

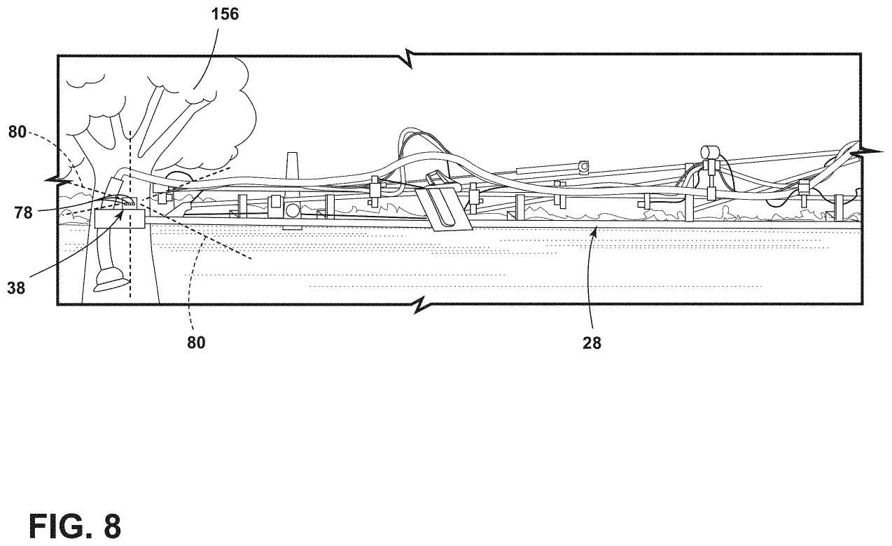

Referring to FIGS. 6-14, in various examples, the imager assemblies 38 may capture images of an area surrounding the provided to the imager assembly 38. In turn, the images may be provided to the computing system 102 for processing. For example, the images provided to the computing system 102 may be processed to determine one or more objects 152 within the field 158. Additionally, a position of the one or more objects 152 may be determined and monitored relative to the vehicle 10. In some instances, if the one or more objects 152 are within a defined distance of the boom assembly 28 or the vehicle 10 or a component thereof, a notification may be generated by the computing system 102. Additionally or alternatively, the images may be processed so that they can individually or in combination and presented as a graphic on the display 134.

With further reference to FIGS. 6-8, in some instances, the imager assembly 38 may include one or more imagers 78 that have offset focal axes 150 relative to one another. As such, a larger area surrounding the imager assembly 38 may be monitored by combining the images from more than one of the imagers 78. For instance, as illustrated, an object 152 in the form of a tree 156 may be positioned within a field 158. While the object 152 is illustrated as a tree 156 in FIGS. 6-14, the object 152 may be any detectable obstruction 154, crop, field feature, or other material without departing from the scope of the present disclosure.

As the vehicle 10 approaches the object 152, sequential images may be provided from each imager 78 to the computing system 102, which may be processed and/or presented on one or more displays 134. In some instances, the computing system 102 may process the sequential images to determine a new location of the object 152 relative to the vehicle 10. In addition, the computing system 102 may receive data related to one or more systems or components of the vehicle 10 to determine a projected path of the vehicle 10 and/or any deflection of the boom assembly 28. Based on the data related to one or more systems or components of the vehicle 10 and the location of the object 152 relative to the vehicle 10, an output may be generated. The output may be in the form of a notification that is provided to the notification system 136 and/or graphics that are presented on one or more displays 134.

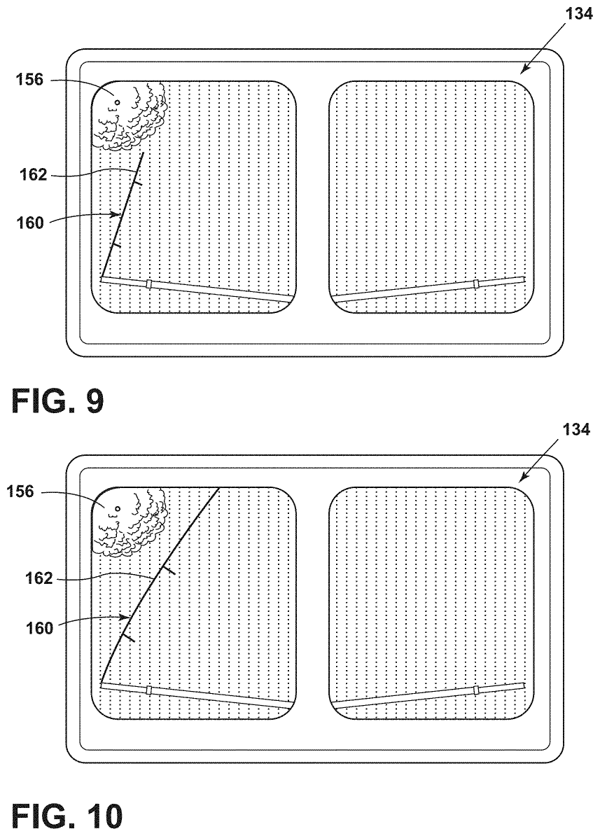

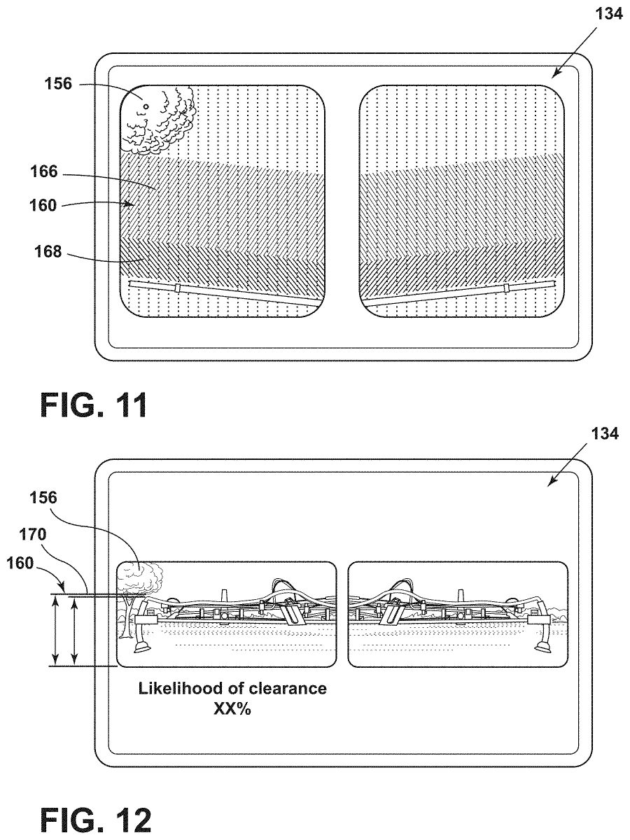

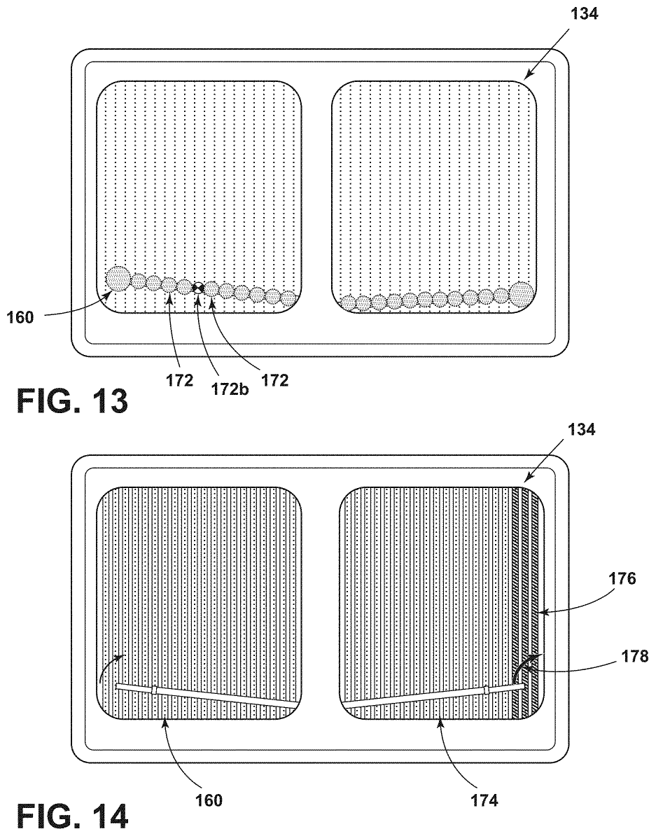

As illustrated in FIGS. 9-14, the graphics provided on the display 134 may include one or more images received by the imager assemblies 38, the one or more images that were received by the imager assemblies 38 and processed by the computing system 102, and/or overlaid illustrations 160. For example, as illustrated in FIGS. 9 and 10, the graphics on the display 134 may include one or more images of the object 152, the field 158, and an overlaid illustration 160 in the form of locus lines 162, 164. Additionally or alternatively, as illustrated in FIG. 11, the graphics on the display 134 may include one or more images of the object 152, the field 158, and an overlaid illustration 160 in the form of one or more zones of interest. Additionally or alternatively, as illustrated in FIG. 12, the graphics on the display 134 may include one or more images of the object 152, the field 158, and an overlaid illustration 160 in the form of a clearance notification. Additionally or alternatively, as illustrated in FIG. 13, the graphics on the display 134 may include one or more images of the field 158 and an overlaid illustration 160 in the form of a projected spray zone 172 of respective nozzle assemblies 30 along the boom assembly 28. Additionally or alternatively, as illustrated in FIG. 14, the graphics on the display 134 may include one or more images of the field 158 and an overlaid illustration 160 in the form of identified rows of the crop relative to the boom assembly 28.

With further reference to FIGS. 9 and 10, in various embodiments, an overlaid illustration 160 is presented on the display 134 in the form of static locus lines 162 and/or dynamic locus lines 164 to aid in maneuvering the vehicle 10 to avoid various objects 152. The static locus lines 162 may be static such that the locus lines 162 are based on the heading of the vehicle 10 and/or dynamically altered based on a movement direction of the vehicle 10 as detected by the steering system 120 in response to a change in the steering wheel angle and other vehicle data related to wheelbase, radius, and gear ratio. Each step of calculating dynamic locus lines 164 can depend on the turning radius and the current steering wheel angle of the vehicle 10, so the locus lines 164 may change as the steering wheel angle is changed. As the steering wheel is rotated, each step and direction the steering wheel moves is reflected in the locus line 164 direction as displayed. Each time the steering angle changes, a replacement set of dynamic locus lines 164 may be displayed. In this respect, the dynamic locus lines 164 present a true path of the boom assembly 28 attached to the vehicle 10 to provide a true sense of where the boom assembly 28 is headed when the boom assembly 28 is in motion.

In some instances, the display 134 can illustrate one or more locus lines 162, 164 forwardly of the boom assembly 28 when the vehicle 10 coupled with the boom assembly 28 is in a first transmission state, such as a transmission state that causes the vehicle 10 to move in a forward direction. In addition, in some instances, the display 134 can illustrate one or more locus lines 162, 164 rearwardly of the boom assembly 28 when the vehicle 10 coupled with the boom assembly 28 is in a second transmission state, such as a transmission state that causes the vehicle 10 to move in a rearward direction.

With further reference to FIG. 11, in various embodiments, the overlaid illustration 160 can include one or more zones of interest 166, 168 to aid in maneuvering the vehicle 10 avoid various objects 152. As illustrated, a first zone of interest 166 may be of a first size and be proximate to the boom assembly 28. In addition, a second zone of interest 168 may be positioned between the first zone of interest 166 and the boom assembly 28 and be of a second size. The first size and the second size may be of a common size or varied from one another. In some instances, when an object 152 is detected within the first zone of interest 166, a first notification may be provided. When the object 152 is detected within the second zone of interest 168, a second notification and/or a corrective action may be accomplished by the control module 132 of the computing system 102.

With further reference to FIG. 12, in some embodiments, the display 134 may present the field 158 and the object 152 to aid in maneuvering the vehicle 10 avoid various objects 152 in a vertical profile. For instance, a clearance notification 170 may include a vertical distance between the object 152 and the field 158 and the top portion of the boom assembly 28 and the field 158 along the projected path of the boom assembly 28. If the object 152 is vertically above the boom assembly 28, the display 134 may provide a notification that the boom is projected to pass the object 152 without contact. Conversely, if the object 152 is projected to not be vertically above the boom assembly 28, the display 134 may provide a notification that the boom may contact the object 152 and/or a likelihood of contact between the obstruction 154 and the boom assembly 28. As such, in some instances, the output of the computing system 102 (FIG. 5) is at least partially based on a height of the obstruction 154 relative to a height of the boom assembly 28.

With further reference to FIG. 13, in several embodiments, the display 134 may present the field 158 and the projected spray patterns of one or more nozzle assemblies 30 along the boom assembly 28. In some instances, if the spray pattern is within a predefined range for the nozzle assembly, the pattern may be illustrated with a first pattern. If the spray pattern deviates from the predefined range for the nozzle assembly, the pattern may be illustrated with a second pattern to notify the operator of a potential issue and the location of the potential issue along the boom assembly 28.

With further reference to FIG. 14, in several embodiments, the display 134 may present the field and an illustration 160 in the form of highlight the crop rows 174, 176 within the field 158. In some instances, the display 134 may further illustrate any variance between the sprayer and the highlight the crop rows 174, 176 that are to have the agricultural product applied thereto. For instance, as illustrated in FIG. 14, the boom assembly 28 may be offset from one or more crop rows 174, 176 that should have the agricultural product applied thereto. As such, the illustration 160 may include a first portion 174 illustrating the one or more rows that have been processed and a second portion illustrating the one or more rows that are to be processed 176. The display 134 may further illuminate the variance such that the operator (and/or the control module 132) can complete a corrective action, which may be in the form of suggestive changes to the position of the vehicle 10, as indicated by arrows 178.

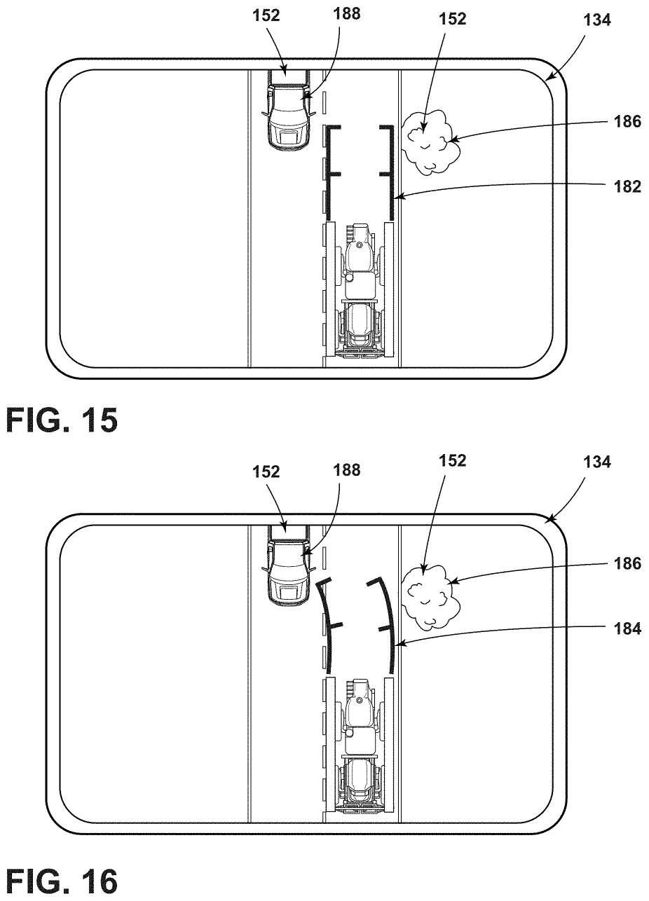

With further reference to FIGS. 15 and 16, in various embodiments, an overlaid illustration 180 is presented on the display 134 in the form of static locus lines 182 and/or dynamic locus lines 184 to aid in maneuvering the vehicle 10 to avoid various objects 152 while the boom assembly 28 is in the folded position. For instance, the objects may be static, such as a tree 186 or another obstacle, and/or mobile, such as an approaching vehicle 188.

As provided herein, one or more imager assemblies 38 (FIG. 2) may be positioned on the boom assembly 28, and/or on any other portion of the vehicle 10. The imager assemblies 38 may be configured to collect one or more images or image-like data indicative of an area surrounding the imager assemblies 38. In turn, the one or more images or image-like data may be used to provide an operator of the vehicle 10 with additional information related to the operation of the vehicle 10 while the boom assembly 28 (FIG. 2) is in the inoperative or folded position (FIG. 2).

The static locus lines 182 may be static and based on the heading of the vehicle 10 and an outer lateral width of the vehicle 10 (or the boom assembly 28). Additionally or alternative, the dynamic locus lines 184 may be dynamically altered based on a movement direction of the vehicle 10 as detected by the steering system 120 in response to a change in the steering wheel angle and other vehicle data related to wheelbase, radius, and gear ratio and an outer lateral width of the vehicle 10 (or the boom assembly 28). Each step of calculating dynamic locus lines 184 can depend on the turning radius and the current steering wheel angle of the vehicle 10, so the locus lines 184 may change as the steering wheel angle is changed. As the steering wheel is rotated, each step and direction the steering wheel moves is reflected in the locus line 164 direction as displayed. Each time the steering angle changes, a replacement set of dynamic locus lines 184 may be displayed. In this respect, the dynamic locus lines 164 present a true path of the boom assembly 28 attached to the vehicle 10 to provide a true sense of where the boom assembly 28 is headed when the boom assembly 28 is in motion while also providing information related to a width of the boom assembly 28 relative to the various obstacles 152.

In some instances, the display 134 can illustrate one or more locus lines 182, 184 forwardly of the boom assembly 28 when the vehicle 10 coupled with the boom assembly 28 is in a first transmission state, such as a transmission state that causes the vehicle 10 to move in a forward direction. In addition, in some instances, the display 134 can illustrate one or more locus lines 182, 184 rearwardly of the boom assembly 28 when the vehicle 10 coupled with the boom assembly 28 is in a second transmission state, such as a transmission state that causes the vehicle 10 to move in a rearward direction.

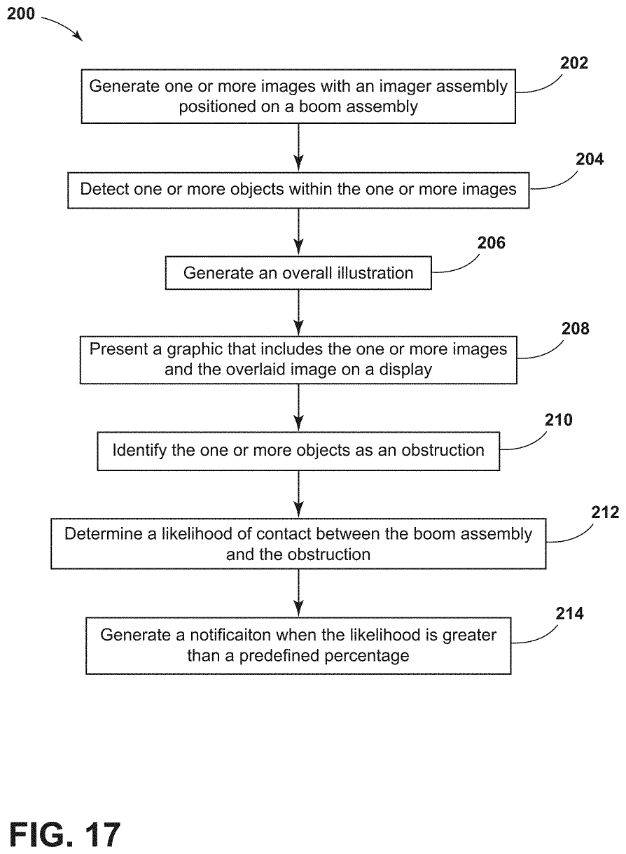

Referring now to FIG. 17, a flow diagram of some embodiments of a method 200 for an agricultural application operation is illustrated in accordance with aspects of the present subject matter. In general, the method 200 will be described herein with reference to the vehicle 10 and the system 100 described above with reference to FIGS. 1-14. However, the disclosed method 200 may generally be utilized with any suitable agricultural vehicle 10 and/or may be utilized in connection with a system having any other suitable system configuration. In addition, although FIG. 17 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As illustrated in FIG. 17, at (202), the method can include generating one or more images with an imager assembly positioned on a boom assembly. As provided herein, each imager assembly may be configured to generate image data of an area surrounding the imager assemblies. In turn, the data may be used to provide an operator of the vehicle with additional information related to the operation of the vehicle. Each imager assembly may include one or more imagers that may correspond to any suitable camera, such as single-spectrum camera or a multi-spectrum camera configured to capture images, for example, in the visible light range and/or infrared spectral range. Additionally, in various embodiments, the camera may correspond to a single lens camera configured to capture two-dimensional images or a stereo camera having two or more lenses with a separate image imaging device for each lens to allow the camera to capture stereographic or three-dimensional images. Alternatively, the imagers may correspond to any other suitable image capture devices and/or other imaging devices capable of capturing “images” or other image-like data. For example, the imagers may correspond to or include radio detection and ranging (RADAR) sensors, light detection and ranging (LIDAR) sensors, and/or any other practicable device.

At (204), the method 200 can include detecting one or more objects within the image data with a computing system. In various examples, the objects may include obstructions, which may be in the form of a building, a tree, a fence, and/or any other object that is to be avoided. The objects may also include the crops or other materials within the field that may have the agricultural product applied thereto.

At (206), the method 200 can include generating an overlaid illustration with the computing system. The overlaid illustration may include locus lines, one or more zones of interest, a clearance notification, a projected spray zone for one or more respective nozzle assemblies, identified rows of crop, and/or any other illustration.

At (208), the method 200 can include presenting a graphic that includes the one or more images and the overlaid image on a display. As provided herein, the display may be positioned within the vehicle associated with the boom assembly and/or remote from the associated vehicle.

At (210), the method 200 can further include identifying the one or more objects as an obstruction with the computing system. In various examples, the objects may include obstructions, which may be in the form of a building, a tree, a fence, and/or any other object that is to be avoided. The objects may also include the crops or other materials within the field that may have the agricultural product applied thereto. When the one or more objects are identified as an obstruction, the method 200, can include generating a notification when the obstruction is within a defined distance of the boom assembly with the computing system. The defined distance may be based on the boom assembly being in a default position and the actual distance to the obstruction may also be based on the boom assembly being in the default position. Additionally or alternatively, the actual distance may be based on one or more sensed conditions of the vehicle and/or the boom assembly, such as the kinematic movement of the boom assembly.

At (212), the method 200 can include determining a likelihood of contact between the boom assembly and the obstruction with the computing system. The computing system may utilize any data processing techniques or algorithms to determine a likelihood of contact between a portion of the boom assembly and the obstruction. In addition, at (214), the method 200 can include generating a notification when the likelihood is greater than a predefined percentage. The notification may be provided to the notification system, the display, the electronic device, and/or any other device.

In various examples, the method 200 may implement machine learning methods and algorithms that utilize one or several vehicle learning techniques including, for example, decision tree learning, including, for example, random forest or conditional inference trees methods, neural networks, support vector machines, clustering, and Bayesian networks. These algorithms can include computer-executable code that can be retrieved by the computing system and/or through a network/cloud and may be used to evaluate and update the boom deflection model. In some instances, the vehicle learning engine may allow for changes to the boom deflection model to be performed without human intervention.

It is to be understood that the steps of any method disclosed herein may be performed by a computing system upon loading and executing software code or instructions which are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions which are tangibly stored on a tangible computer-readable medium. The computing system loads the software code or instructions via a direct interface with the computer-readable medium or via a wired and/or wireless network. Upon loading and executing such software code or instructions by the controller, the computing system may perform any of the functionality of the computing system described herein, including any steps of the disclosed methods.

The term “software code” or “code” used herein refers to any instructions or set of instructions that influence the operation of a computer or controller. They may exist in a computer-executable form, such as vehicle code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An agricultural system comprising:
a boom assembly;
an imager assembly associated with the boom assembly and configured to capture image data depicting at least a portion of the boom assembly; and
a computing system communicatively coupled to the imager assembly and a display, the computing system being configured to:
receive the image data from the imager assembly; and
present a graphic on the display based on the image data, the graphic including at least one overlaid illustration.

2. The system of claim 1, wherein the portion of the boom assembly is an outer portion of the boom assembly.

3. The system of claim 1, wherein the overlaid illustration is one or more locus lines.

4. The system of claim 3, wherein the one or more locus lines are based on a heading direction of a vehicle associated with the boom assembly.

5. The system of claim 3, wherein the one or more locus lines are altered with a change in a steering angle of a vehicle associated with the boom assembly.

6. The system of claim 1, wherein the overlaid illustration is one or more zones of interest.

7. The system of claim 6, wherein the one or more zones of interest includes a first zone of interest forward of the boom assembly and a second zone of interest positioned between the first zone of interest and the boom assembly.

8. The system of claim 1, wherein the overlaid illustration is a projected spray zone of one or more nozzle assemblies positioned along the boom assembly.

9. The system of claim 5, wherein the overlaid illustration is one or more rows of crop, and wherein the overlaid illustrated includes a first portion illustrating the one or more rows that have been processed and a second portion illustrating the one or more rows that are to be processed.

10. A method for an agricultural application operation, the method comprising:
generating, with an imager assembly positioned on a boom assembly, image data;
detecting, with a computing system, one or more objects within the image data;
generating, with the computing system, an overlaid illustration; and
presenting, on a display, a graphic that includes the one or more images and the overlaid image.

11. The method of claim 10, further comprising:
identifying, with the computing system, the one or more objects as an obstruction.

12. The method of claim 11, further comprising:
generating, with the computing system, a notification when the obstruction is within a defined distance of the boom assembly.

13. The method of claim 11, further comprising:
determining, with the computing system, a likelihood of contact between the boom assembly and the obstruction; and
generating a notification when the likelihood is greater than a predefined percentage.

14. The method of claim 11, wherein the overlaid illustration is one or more locus lines.

15. The method of claim 10, wherein the overlaid illustration is one or more zones of interest.

16. An agricultural system comprising:
a vehicle;
a boom assembly operably coupled with the vehicle;
an imager assembly associated with the boom assembly and configured to capture image data depicting at least a first portion of the boom assembly; and
a computing system communicatively coupled to the imager assembly and a display, the computing system being configured to:
receive the image data from the imager assembly;
determine one or more objects within the image data;
identify an obstruction within the one or more objects; and
generate an output based on a location of the obstruction relative to the boom assembly.

17. The agricultural system of claim 16, wherein the output includes altering a position of the boom assembly relative to the vehicle.

18. The agricultural system of claim 16, wherein the output includes providing a graphic of the boom assembly and the obstruction on a display.

19. The agricultural system of claim 18, wherein the output further includes providing an overlaid illustration within the graphic.

20. The agricultural system of claim 16, wherein the output is at least partially based on a height of the obstruction relative to a height of the boom assembly.
